(19) United States
(12) Patent Application Publication
(10) Pub. No.: US 2016/0086237 A1
(43) Pub. Date: Mar. 24, 2016

(54) SYSTEMS AND METHODS FOR A NETWORK FOR MARKETPLACES

(71) Applicant: GARAGE CELL, INC., Los Angeles, CA (US)

(72) Inventors: Michael YUM, Los Angeles, CA (US); Seong-Uk JEON, Los Angeles, CA (US); Dongpil LIM, Los Angeles, CA (US)

(21) Appl. No.: 14/859,257

(22) Filed: Sep. 19, 2015

Related U.S. Application Data
(60) Provisional application No. 62/053,048, filed on Sep. 19, 2014.

(51) Int. Cl. G06Q 30/06; H04L 12/58; H04L 29/08

(52) U.S. Cl. CPC G06Q 30/0601; H04L 67/10; H04L 51/32

(57) ABSTRACT

The disclosed embodiments relate to connecting together online communities, and users or members of those communities, over a network by using a back-end server configured in accordance with the disclosed embodiments.

### CROSS-REFERENCE TO RELATED APPLICATIONS

This application claims priority to U.S. Provisional Patent Application No. 62/053,048, which was filed Sep. 19, 2014. The disclosure of the Provisional application is herein incorporated by reference in its entirety and for all purposes.

### FIELD

The present disclosure generally relates to connecting online communities, and users or members of those communities, over a network.

### BACKGROUND

In a conventional online community, such as a marketplace, a server is connected to a database that, in turn, relays information to a single avenue (e.g., the marketplace itself). Users of the marketplace are connected to the marketplace and are able to conduct transactions by sending and receiving data to and from the marketplace. For example, a user may be required to access information from the server (e.g, via a product webpage, search engine, or the like) in order to buy or sell a product. Thus, a user attempting to conduct a transaction with another user of the marketplace will need to go through the marketplace itself, which operates as an intermediary or “middle man” between the user and other users and/or other marketplaces.

In the typical arrangement just described, users of one marketplace are unable to directly conduct transactions with, or interact with users of, another marketplace. Should they desire to do so, they must typically register or establish an account with the second marketplace. Thus, there is a need to directly connect users of different marketplaces and enable to them to conduct transactions and interact with one another without needing to register or establish accounts with each such marketplace.

### SUMMARY

In some embodiments, a system for networking online communities includes a set of clubs, where each club in the set of clubs has identification data for identifying the club. Each club also includes one or more member users and a set of operations, where each operation in the set of operations allows one member user to interact with another member user. The system for networking online communities additionally includes a back-end server for interconnecting, over a network, the set of clubs.

### BRIEF DESCRIPTION OF THE DRAWINGS

The accompanying drawings, which are included as part of the present specification, illustrate the presently preferred embodiments and, together with the general description given above and the detailed description of the preferred embodiment given below, serve to explain and teach the principles described herein.

FIGS. 1a, 1b, and 1c are block diagrams illustrating one embodiment of a system for networking online communities.

FIGS. 2a, 2b, 2c, 2d, 2e, and 2f are block diagrams illustrating embodiments of exemplary club pages within the system for networking online communities of FIGS. 1a, 1b, and 1c.

FIGS. 3a, 3b, 3c, 3d, 3e, 3f, 3g, and 3h are block diagrams illustrating embodiments of exemplary user interface pages within the system for networking online communities of FIGS. 1a, 1b, and 1c.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings disclosed herein and do not limit the scope of the claims.

### DETAILED DESCRIPTION

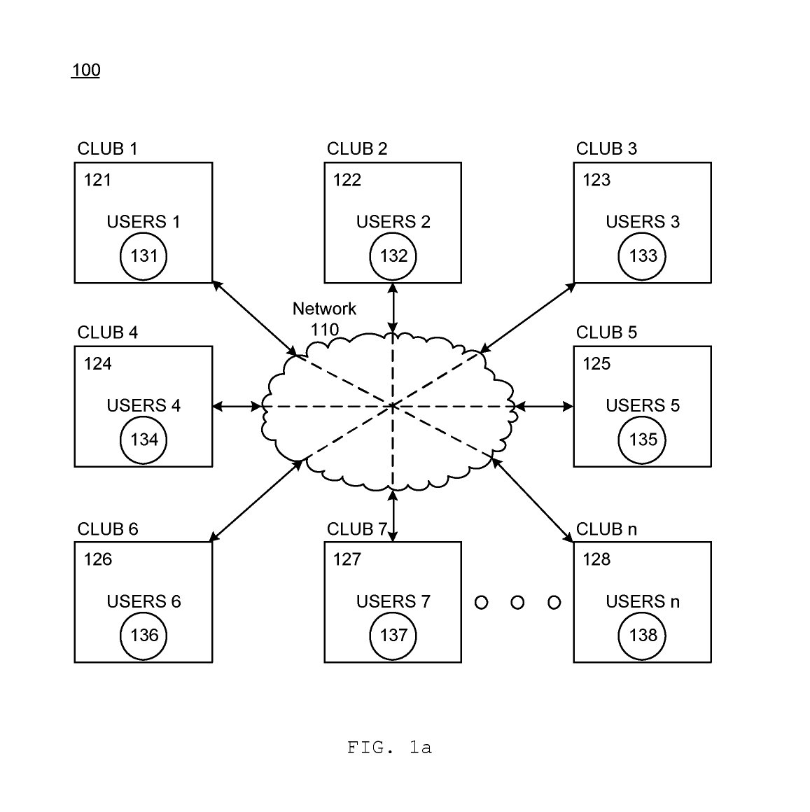

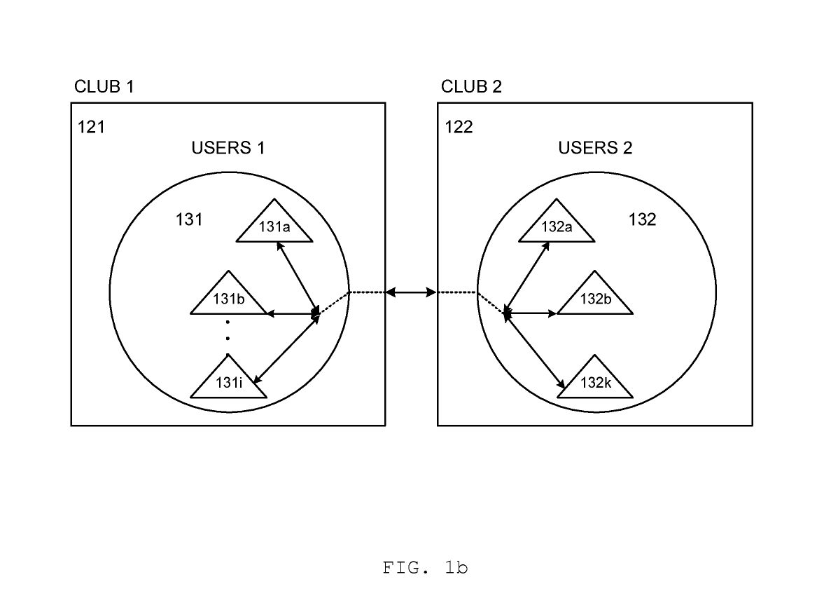

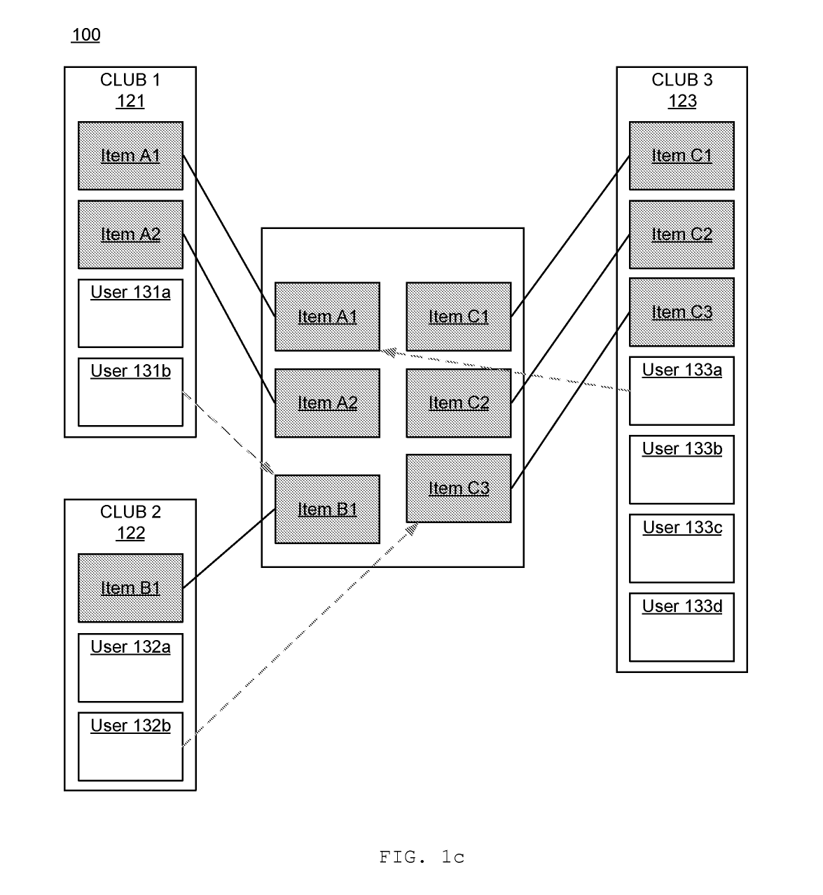

FIG. 1a is a block diagram illustrating a system 100 for networking online communities. The system 100 can include a back-end server architecture, to interconnect one or more online communities 121-128 over a network 110. The online communities 121-128 will herein be referred to as “clubs,” “club pages,” “club rooms” and the like. Each of the clubs 121-128 can have, or be associated with, a set of users. For example, users 131-138 may be members of one or more of the clubs 121-128. Thus, the system 100 interconnects the clubs 121-128 and the users 131-138, for example, as shown in FIG. 1b.

The system 100 allows users to create social networks based on interests where the users are connected to one another through clubs (rather than, for example, through a centralized server acting as a “middleman”). Users may create new clubs as well as join or become a member of existing ones. For convenience, users associated with a given club will be referred to as “members” of that club.

A club may provide an interface for its member users to interact with one another. For example, users of a club may conduct business transactions and exchange messages and photographs with one another. Business transactions may include buying, selling, renting or leasing a product or service. Users may also define and engage in unique transactions, such as bartering a particular product or service for another.

The system 100 sends and receives data streams directly to and from the users of a given club, in real-time. Thus, a user may receive data streams from the system 100 for each of the clubs associated with the user. Because each user of a club receives data directly from the system 100, users of that club may interact directly with one another. For example, when a user 131a of the club 121 makes an offer to purchase an item to another user 131b, the system 100 performs at least two tasks: (1) it accesses the prospective buyer's profile data to pull the club and item data, and (2) it accesses the prospective seller's profile data and connects the prospective seller directly with the prospective buyer.

As illustrated in FIG. 1a, users of one club can interact with users of another club. The system 100 may, for example, enable a product that is offered for sale by a user 131a of club 121 to also be offered for sale in club 122. This effectively allows user 131a of club 121 to engage in transactions with users of club 122, without necessitating that user 131 a become a member of club 122. This is shown, for example, in FIG. 1c, which illustrates how a user of one club (e.g., user 131b of club 121) can engage in a transaction for an item that is offered for sale and described by a user of another club (e.g., item B1 of club 122). System 100, therefore, networks users of different clubs together by enabling them to seamlessly interact with one another.

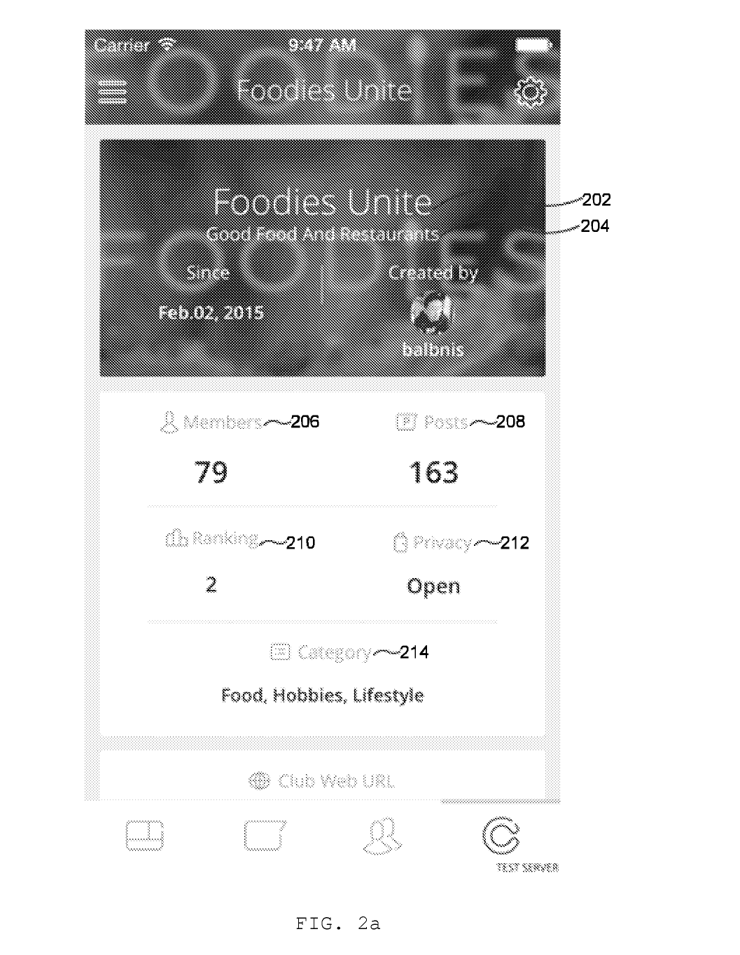

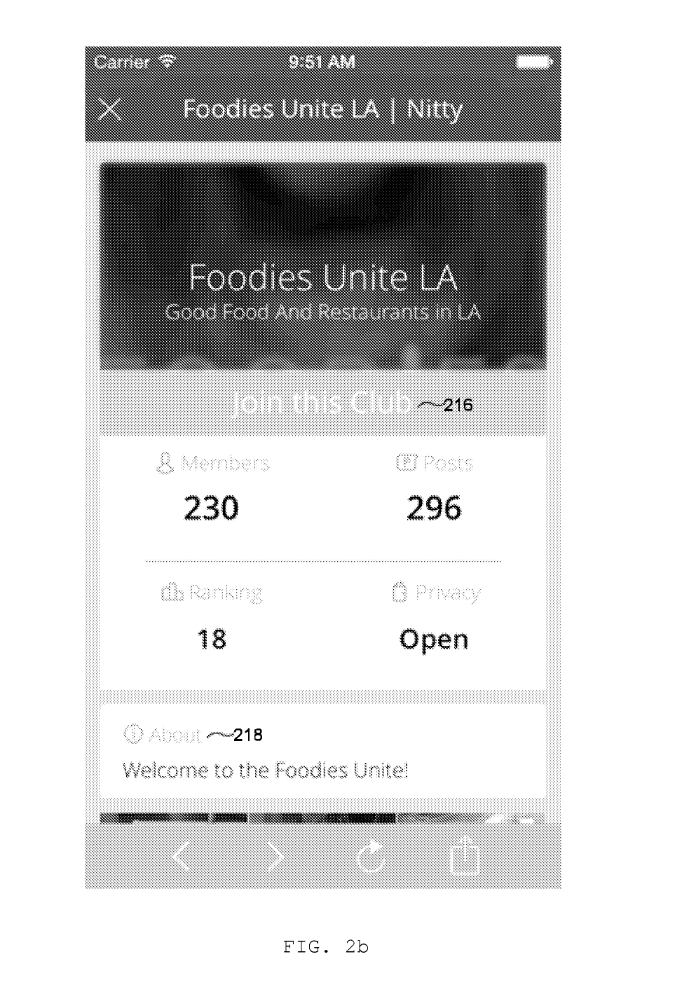

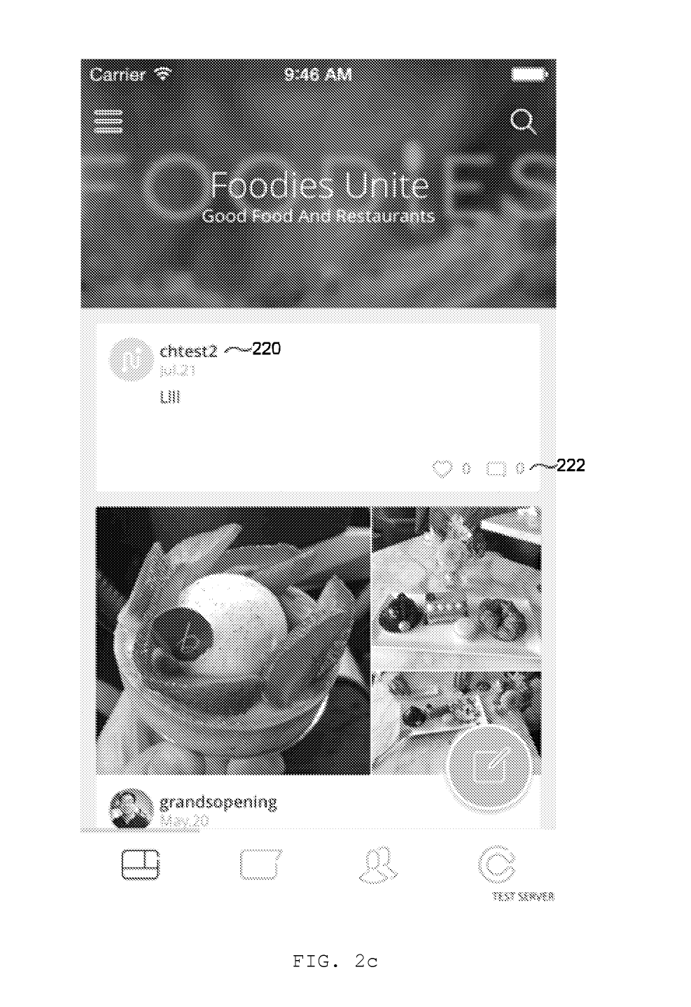

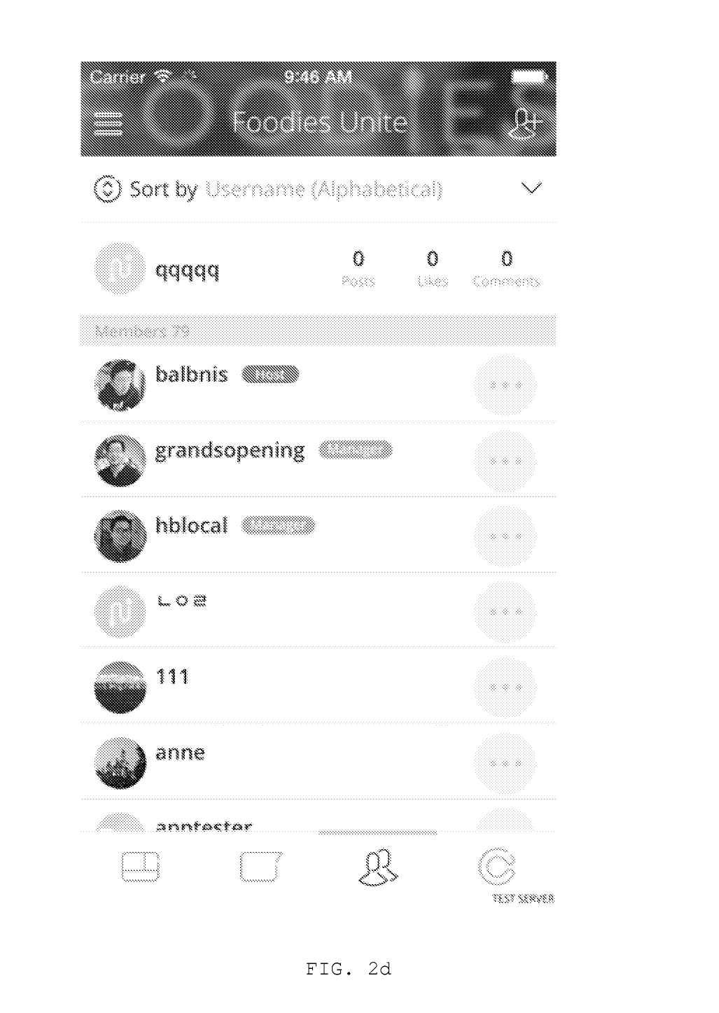

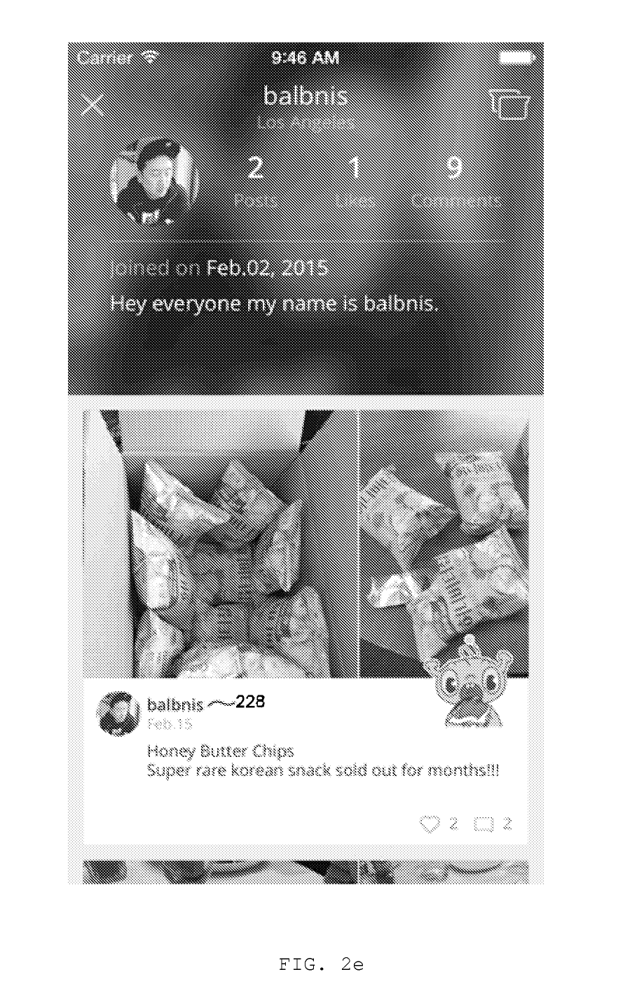

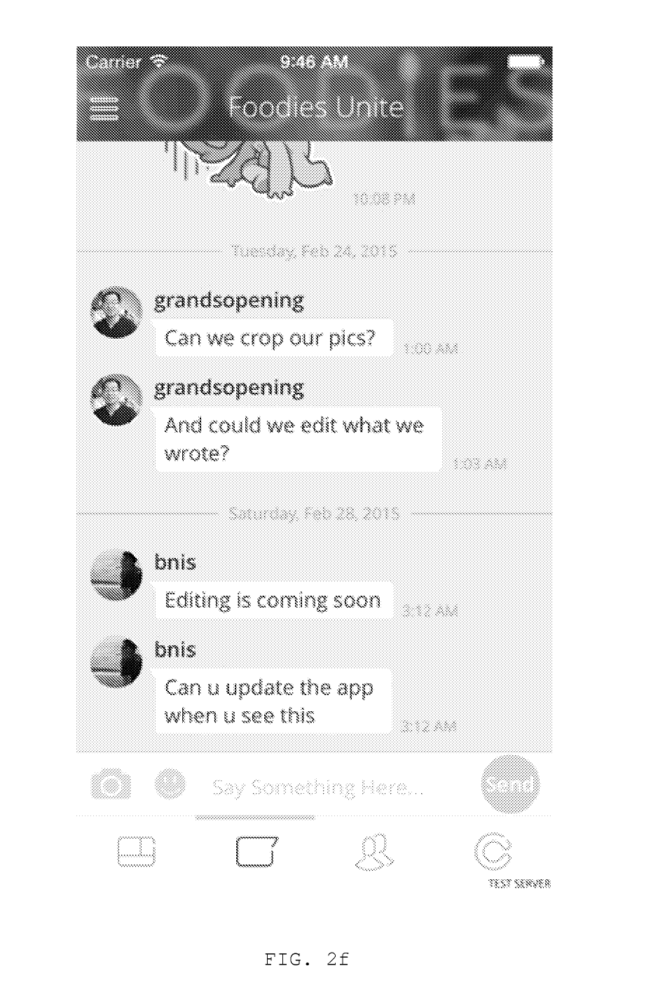

FIGS. 2a, 2b, 2c, 2d, 2e, and 2f are block diagrams illustrating exemplary club pages within system 100, consistent with disclosed embodiments. Shown in FIG. 2a is an exemplary page for a club identified as “Foodies Unite” (indicated by reference numeral 202) and briefly described as “Good Food And Restaurants” (indicated by reference numeral 204). Additional information describing the club—such as its creation date (“Feb. 2, 2015”), creator (“balbnis”), number of members (“79,” indicated by reference numeral 206), number of posts (“163,” indicated by reference numeral 208), ranking (“2,” indicated by reference numeral 210), privacy setting (“open,” indicated by reference numeral 212), category (“Food, Hobbies, Lifestyle,” indicated by reference numeral 214), a club banner, wallpaper or background picture, and a web URL—may also be provided on the club page. Shown in FIG. 2b is another exemplary page for a club identified as “Foodies Unite LA.” As additionally indicated in FIG. 2b, a user may join this club by tapping or clicking (on their mobile device (e.g., smart phone or tablet PC) or PC) on the “Join this Club” banner (indicated by reference numeral 216) prominently displayed in contrasting font towards the middle of the club page. Additional information about the club (“Welcome to the Foodies Unite!” indicated by reference numeral 218) may also be displayed on the club page.

Club identifying information and descriptors help users distinguish between clubs, search among existing clubs, select clubs to join, and/or decide whether to create a new club. For example, a user looking for a “foodie” related club with active members may decide to join the “Foodies Unite” and/or “Foodies Unite LA” clubs shown in FIGS. 2a and 2b, respectively, each of which has over 75 members and 150 posts. On the other hand, a user who is instead looking to form a smaller foodie community may decide to create their own club. Club identifying information and descriptors also help to uniquely identify any given club. In some embodiments, information such as a club name, its description(s), category, privacy setting, web URL, and the like, may optionally be modified by users (for example, by a club administrator, host, or manager), even after a club has been created. A club may include user data for each of its member users, such as, for example, profile information (e.g., user name, profile picture and/or icon, introduction or an “about me” description, and the like), account creation date, last login information, and the like.

FIG. 2c shows an exemplary post made by a user in a club. As indicated by reference numeral 220, the user “chtest2” made a post on “July 21” with the text “L111.” User posts may include any combination of text, photographs (such as those appearing below the text “L111” in FIG. 2c), emoticons, hyperlinks, action buttons (e.g., offers to buy or sell, survey questions or responses, etc.) and the like. Reference numeral 222 indicates the number of “likes” (“0” appears next to the heart symbol) and number of comments (“0” appears next to the comment box symbol) in response to the post. A user post is typically viewable by, and may be responded to by, the members of the club. In some embodiments, system 100 may use privacy and other settings to limit access to a particular user post (for example, to a specific subset of the club members). For example, a user may configure a test post such that only the club's administrators, managers and/or hosts are able to view and/or respond to the post.

FIG. 2d shows an exemplary listing of members of a club. As shown, the club “Foodies Unite” has 79 members (only several of those members are shown), including a host member (“balbnis”) and manager members (“grandsopening” and “hblocal”). System 100 may display a small icon depicting a user profile picture, banner, or symbol next to each member. System 100 may also provide information about any particular member. For example, FIG. 2d shows that the member “qqqqq” currently has made 0 posts, has received 0 likes, and has received 0 comments. System 100 may update such information for a user in real-time as the user makes posts and engages in club activity. FIG. 2e shows additional information for a particular club member (“balbnis”). As shown, balbnis has made 2 posts, and received 1 like and 9 comments since joining the club (“Feb. 2, 2015). Also shown is a brief member description (“Hey everyone my name is balbnis.”) and recent posts made by the member (a combination of text and photographs posted by balbnis on Feb. 15, indicated by reference numeral 228). FIG. 2f shows exemplary chat room functionality that system 100 may provide for users to communicate with one another. As shown in FIG. 2f, two members of the club “Foodies Unite” (“grandsopening” and “bnis”) are exchanging messages in a live group chat accessible to the club's members.

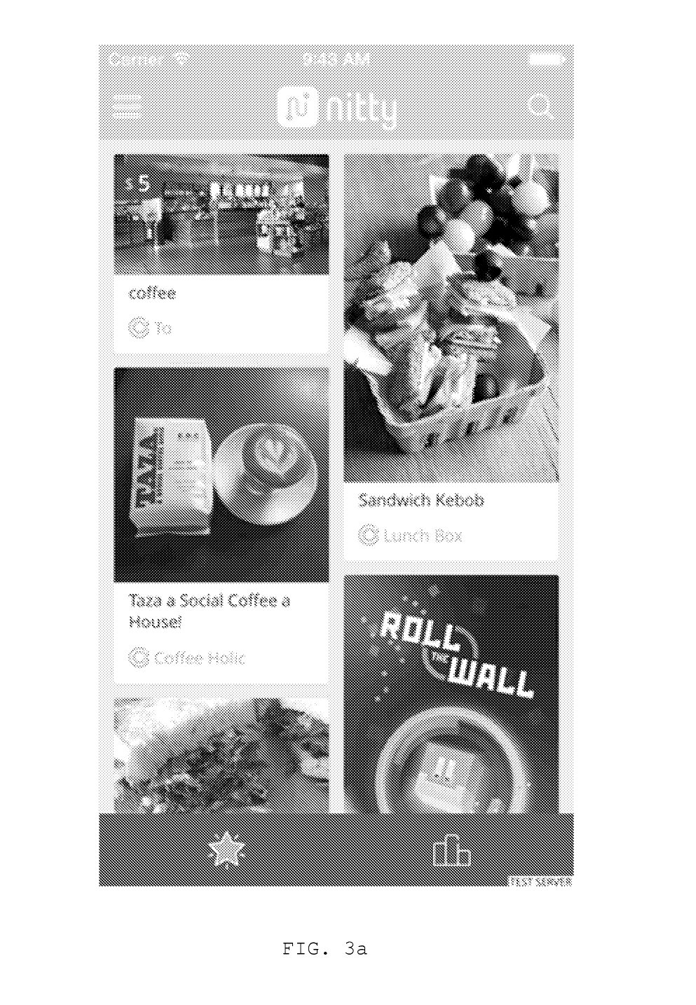

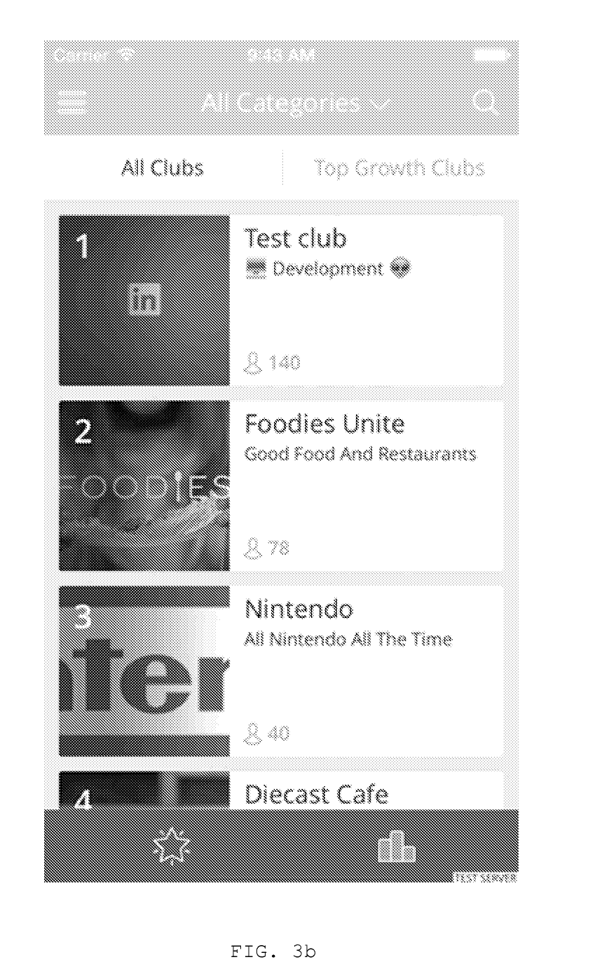

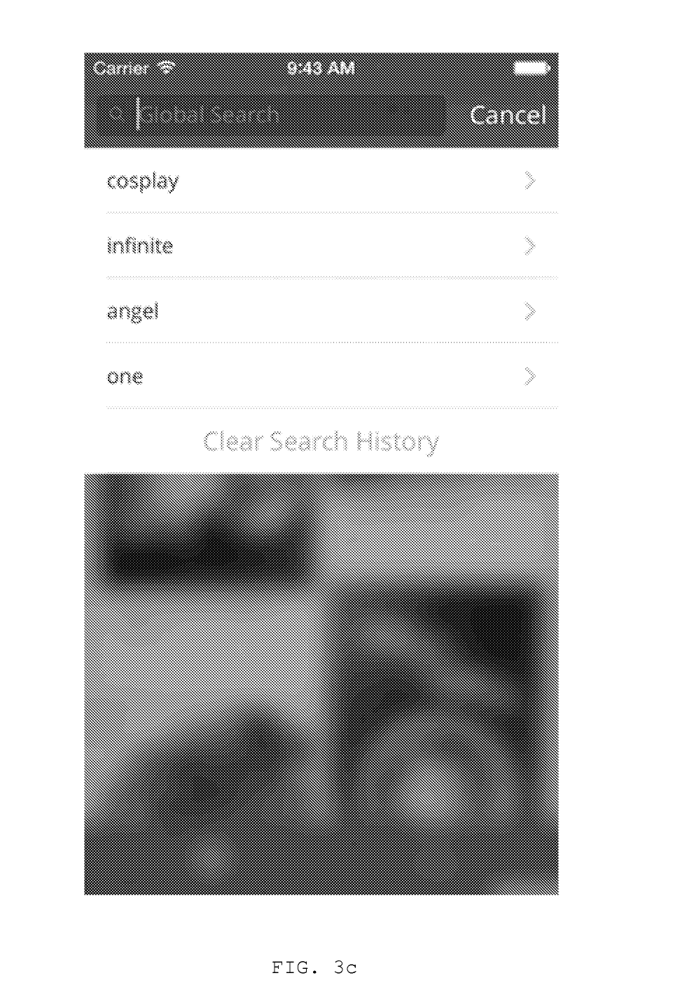

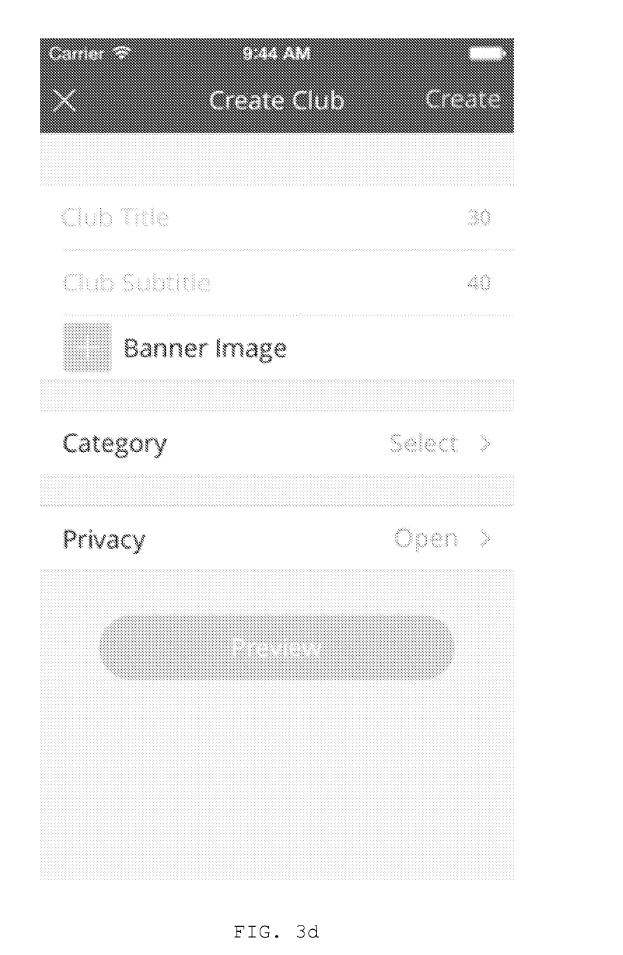

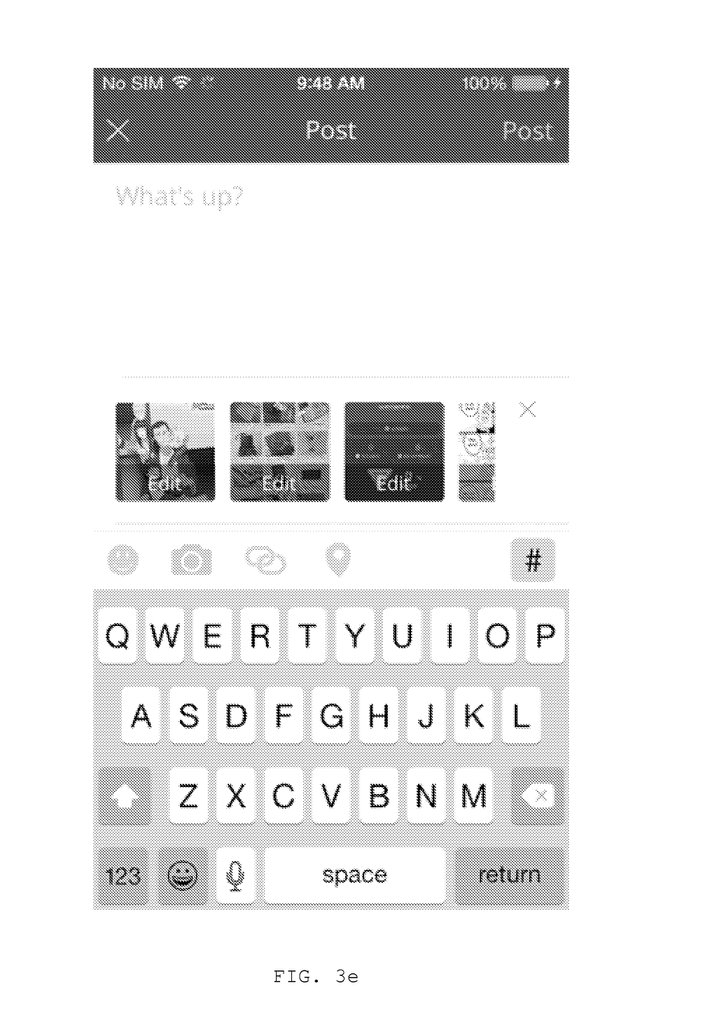

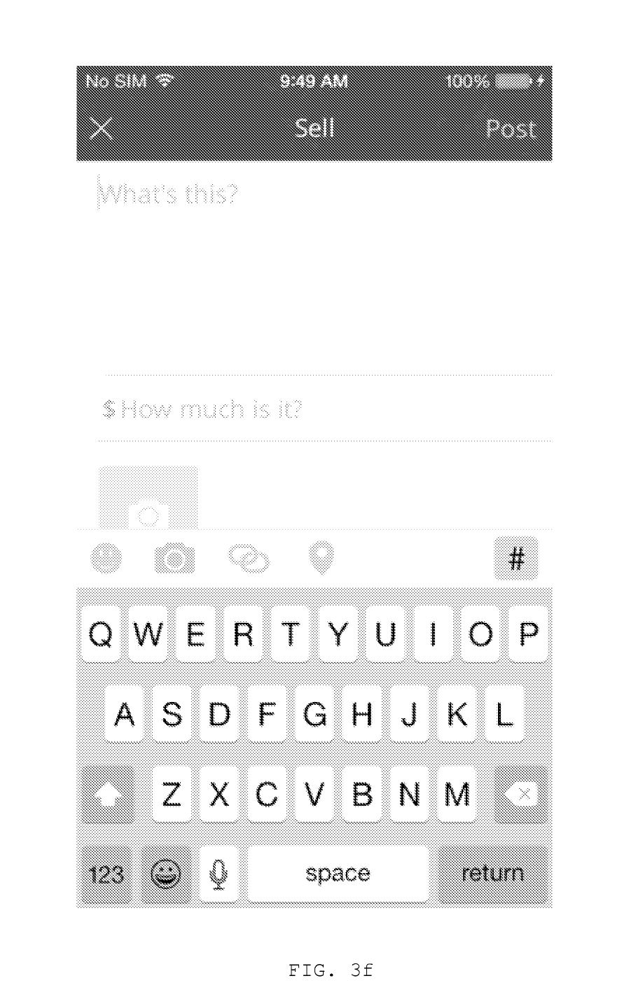

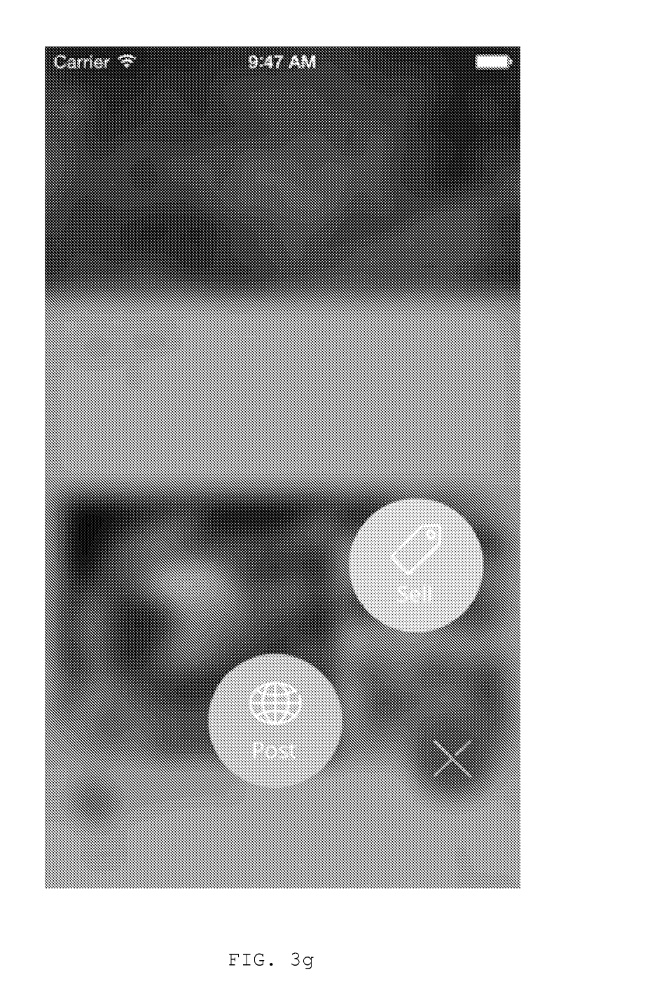

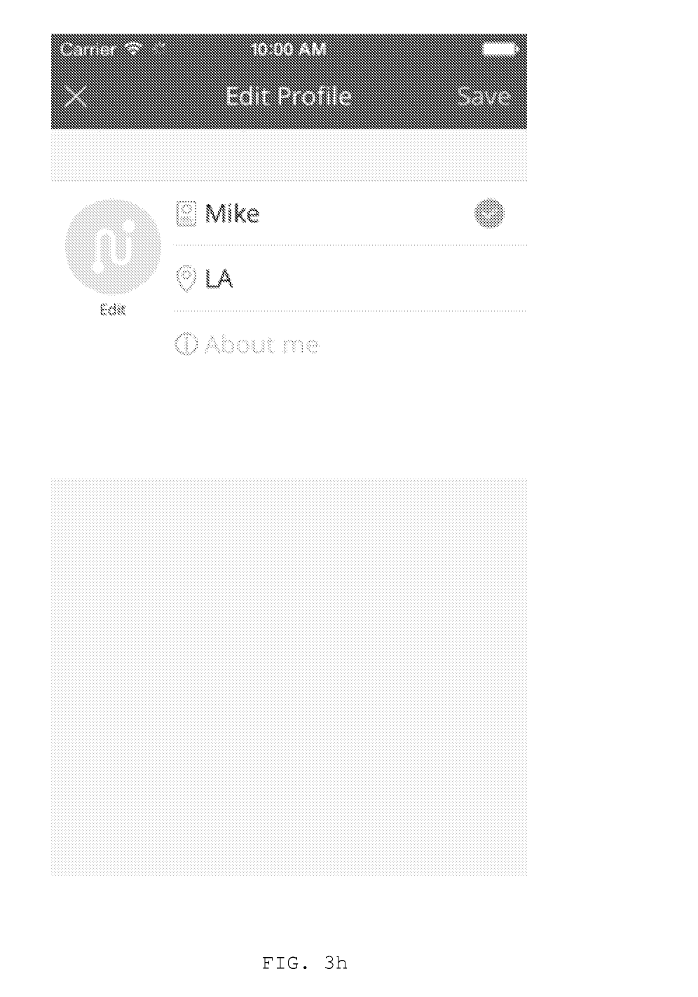

FIGS. 3a, 3b, 3c, 3d, 3e, 3f, 3g, and 3h are block diagrams illustrating exemplary user interface pages within system 100, consistent with disclosed embodiments. FIGS. 3a and 3b show clubs that system 100 may display to a user for the user to consider joining. System 100 may select clubs to display based on various criteria, such as, for example, a user's location and profile settings, the categories of clubs that the user is currently associated with, and the like. A user may also search for clubs by name or category (as illustrated in FIG. 3c) or create a club (as illustrated in FIG. 3d). Users may additionally search for clubs and/or users based on keywords found within, or associated with, a particular club and/or user.

FIGS. 3e, 3f, and 3g illustrate an interface for a user to create a post, such as a post containing text and/or pictures (FIGS. 3e and 3g) or an offer for sale (FIGS. 3f and 3g). In some embodiments, a user may create at least three types of posts: (1) a post about offering an item for sale or barter, including information such as one or more item photographs or videos, an item price, a text description, and the like, (2) a post about an event, such as information about signing up for and attending a social event, including, for example, event host details and map and/or navigation information associated with the event location, and (3) a post concerning news, via text, images, and/or hyperlinks, that may be relevant to the club and/or its members. As mentioned above, system 100 may enable a user to send an offer in response to a post about offering an item for sale or barter.

In the description above, for purposes of explanation only, specific nomenclature is set forth to provide a thorough understanding of the present disclosure. However, it will be apparent to one skilled in the art that these specific details are not required to practice the teachings of the present disclosure.

The language used to disclose various embodiments describes, but should not limit, the scope of the claims. For example, in the previous description, for purposes of clarity and conciseness of the description, not all of the numerous components shown in the figures are described. The numerous components are shown in the drawings to provide a person of ordinary skill in the art a thorough, enabling disclosure of the present specification. The operation of many of the components would be understood and apparent to one skilled in the art. Similarly, the reader is to understand that the specific ordering and combination of process actions described is merely illustrative, and the disclosure may be performed using different or additional process actions, or a different combination of process actions.

Each of the additional features and teachings disclosed herein can be utilized separately or in conjunction with other features and teachings for protective coverings. Representative examples using many of these additional features and teachings, both separately and in combination, are described in further detail with reference to the attached drawings. This detailed description is merely intended for illustration purposes to teach a person of skill in the art further details for practicing preferred aspects of the present teachings and is not intended to limit the scope of the claims. Therefore, combinations of features disclosed in the detailed description may not be necessary to practice the teachings in the broadest sense, and are instead taught merely to describe particularly representative examples of the present disclosure. Additionally and obviously, features may be added or subtracted as desired without departing from the broader spirit and scope of the disclosure. Accordingly, the disclosure is not to be restricted except in light of the attached claims and their equivalents.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

What is claimed is:

1. A system for networking online communities, comprising:
a set of clubs, wherein each club in the set of clubs comprises:
identification data for identifying the club within the set of clubs;
user data for one or more member users of the club;
a set of operations, wherein each operation in the set of operations allows one member user to interact with another member user; and
a back-end server for interconnecting, over a network, the set of clubs.

2. The system of claim 1, wherein each club in the set of clubs is connected over the network to every other club in the set of clubs.

3. The system of claim 1, wherein the identification data comprises at least one of: a creation date, a creator, a number of members, a number of posts, a ranking, a privacy setting, a category, a club banner, and a web URL.

4. The system of claim 1, wherein:
the set of clubs includes a first club comprising a set of first member users;
the set of clubs includes a second club comprising a set of second member users; and
a user of the set of first member users is connected, over the network, to a user of the set of second member users;

5. The system of claim 1, wherein the set of operations comprises at least one of:
making an offer to sell an item, making an offer to purchase an item, making an offer to barter an item, providing information about an event, and providing a news update.
